(19) United States
(12) Patent Application Publication
(10) Pub. No.: US 2026/0112964 A1
(43) Pub. Date: Apr. 23, 2026

(54) POWER FOLDBACK DEPENDING ON TEMPERATURE

(71) Applicant: Infineon Technologies Austria AG, Villach (AT)

(72) Inventors: Allan SALIVA, Pleasanton, CA (US); Alfredo MEDINA-GARCIA, München (DE); Tobias HAUKE, München (DE)

(21) Appl. No.: 19/360,247

(22) Filed: Oct. 16, 2025

(30) Foreign Application Priority Data
Oct. 17, 2024 (DE) 102024210066.8

(51) Int. Cl. H02M 1/32; H02J 7/00; H02M 3/335

(52) U.S. Cl. CPC H02M 1/327; H02J 7/65; H02M 3/33507; H02J 2207/20

(57) ABSTRACT

A control circuit is presented. The control circuit may be configured to control operation of a power converter. The control circuit may be configured to receive a temperature value from a temperature sensor. The control circuit may be configured to control an output current of the power converter based on the temperature value. The power converter may comprise a transformer with a primary side and a secondary side, and the control circuit may be configured to control the output current of by controlling the switching behavior of switching elements coupled to the primary side of the transformer. In addition, a battery charger device including said control circuit and said power converter is presented.

### RELATED APPLICATION

This application claims priority to German Patent Application No. 102024210066.8, filed on October 17, 2024, entitled “Power foldback depending on temperature”, which is incorporated by reference herein in its entirety.

### TECHNICAL FIELD

The present document relates to over temperature protection OTP in battery charger devices. In particular, the present document relates to OTP in hybrid flyback power converters which may be applied in battery charger devices.

### BACKGROUND

In battery charger applications, the chargers are often tightly sealed inside plastic enclosure with no available airflow. This may present thermal challenges especially in small size design. The temperature of the power supply unit PSU is approximately proportional to the power losses. As power losses rise, controlling the enclosure temperature to meet specifications may become more challenging.

### SUMMARY

According to an aspect, a control circuit is presented. The control circuit may be configured to control operation of a power converter. The control circuit may be configured to receive a temperature value from a temperature sensor. The control circuit may be configured to control an output current of the power converter based on the temperature value. The control circuit may comprise one or more processors for implementing or at least initiating the functional features of the control circuit described within this document. Specifically, the control circuit may comprise a microcontroller MCU for carrying out the described functions. In addition, the control circuit may comprise a memory unit.

The control circuit may be configured to control switching of the switching elements of the power converter. The switching elements may be implemented with any suitable devices, such as, for example, metal-oxide-semiconductor field effect transistors MOSFETs, insulated-gate bipolar transistors IGBTs, MOS-gated thyristors, or any other suitable power devices. For instance, the switching elements may be implemented using a III-V compound semiconductor material such as e.g. GaN- high-electron-mobility transistors HEMTs. Each switching element may have a control terminal (e.g. a gate) to which a respective control signal (e.g. driving voltage/current) may be applied to turn the switching element on (i.e. to close the switching element) or to turn the switching element off (i.e. to open the switching element).

The features of the control circuit described within this document, and in particular the functional features of the control circuit, may be implemented by respective software or hardware units, or by a combination of both. Hardware units may be implemented using digital or analog circuit elements, or by a combination of both. The power converter may be a DC/DC power converter or an AC/DC power converter. The temperature sensor may be external or internal with regard to the control circuit.

The control circuit may be configured to reduce the output current or output power of the power converter if the temperature value exceeds a first threshold value. In particular, the control circuit may be configured to reduce the output current of the power converter only if the temperature value exceeds the first threshold value. The control circuit may be configured to linearly reduce the output current over temperature between the first threshold value and a second threshold value. Alternatively, the control circuit may be configured to reduce the output current over temperature in a non-linear manner between the first threshold value and the second threshold value

The control circuit may be configured to keep the output current below an upper current limit. The control circuit may be configured to reduce the upper current limit if the temperature value exceeds a first threshold value. For example, the control circuit may be configured to keep the upper current limit constant if the temperature value is smaller than the first threshold value. In other words, when the temperature value is smaller than the first threshold value, the control circuit may be configured to perform over current protection OCP using said constant upper current limit. At this, the control circuit may control/regulate the output current according to regulation objectives (e.g. based on one or more feedback parameters of the power converter) while preventing the output current from exceeding said upper current limit. When the temperature rises above the first threshold value, the control circuit may still continue controlling the output current according said regulation objectives. However, the upper current limit may be reduced when the temperature value exceeds the first threshold value.

The control circuit may be configured to linearly reduce the upper current limit over temperature between the first threshold value and a second threshold value. The control circuit may be configured to reduce the upper current limit only based on the temperature value, and independent of other feedback parameters of the power converter. Such feedback parameters may include e.g. the input voltage, the output voltage, or the output current of the power converter.

The control circuit may be configured to receive another feedback parameter indicative of the output current or the output voltage of the power converter. The control circuit may be configured to control the output current based on said another feedback parameter under the condition that the output current does not exceed the upper current limit.

The control circuit may be configured to enter protection mode and shut down operation of the power converter if the temperature value exceeds a second threshold value. In protection mode, the control circuit may be configured to stop generating control signals for controlling the switching elements of the power converter.

The power converter may comprise a transformer with a primary side and a secondary side. The control circuit may be configured to control the output current of the power converter based on the temperature value by controlling the switching behavior of switching elements coupled to the primary side of the transformer. In other words, said switching elements may be electrically isolated from the secondary side of the transformer. The power converter may comprise a resonant capacitor and a half-bridge coupled to the primary side of the transformer. The switching elements may form said half-bridge. The power converter may be also denoted as hybrid-flyback power converter, or as a power converter based on a resonant asymmetrical half-bridge flyback topology. Alternatively, the power converter may be based on an inductor-inductor-capacitor LLC topology.

The control circuit may be configured to ignore or deactivate, if the temperature value exceeds a first threshold value, an overcurrent protection function based on a feedback voltage indicative of an output voltage of the power converter. In particular, the control circuit may be configured to ignore said feedback voltage if the temperature value exceeds the first threshold value. The temperature sensor may be external to the control circuit and may comprise a thermistor, and the temperature value may comprise a voltage across said thermistor. The thermistor, also known as thermally sensitive resistor, may be e.g. a negative temperature coefficient NTC thermistor or a positive temperature coefficient PTC thermistor.

According to another aspect, a battery charger device is presented. The battery charger device may comprise the control circuit and the power converter described throughout this document. The power converter may comprise a transformer with a primary side and a secondary side. The control circuit may be configured to control the output current of the power converter based on the temperature value by controlling the switching behavior of switching elements coupled to the primary side of the transformer. The control circuit may be galvanically isolated from electrical signals of the secondary side of the transformer.

According to yet another aspect, a method of controlling a power converter is presented. The method may comprise receiving, by a control circuit, a temperature value from a temperature sensor. The method may comprise controlling, by the control circuit, an output current of the power converter based on the temperature value.

The method may comprise reducing, by the control circuit, the output current of the power converter if the temperature value exceeds a first threshold value. The method may comprise linearly reducing the output current over temperature between the first threshold value and a second threshold value.

In particular, the method may comprise keeping the output current below an upper current limit. The method may comprise reducing the upper current limit if the temperature value exceeds the first threshold value. The method may comprise linearly reducing the upper current limit over temperature between the first threshold value and the second threshold value. The method may comprise reducing the upper current limit only based on the temperature value, and independent of other feedback parameters of the power converter.

The method may comprise entering protection mode and shutting down operation of the power converter if the temperature value exceeds the second threshold value.

The power converter may comprise a transformer with a primary side and a secondary side. The method may comprise controlling the output current of the power converter based on the temperature value by controlling the switching behavior of switching elements coupled to the primary side of the transformer. The power converter may comprise a resonant capacitor and a half-bridge coupled to the primary side of the transformer, and the switching elements may form said half-bridge.

The method may comprise deactivating, if the temperature value exceeds a first threshold value, an overcurrent protection function based on a feedback voltage indicative of an output voltage of the power converter. The external temperature sensor may comprise a thermistor, and the temperature value may comprise a voltage across said thermistor.

According to another aspect, a computer program is presented. The computer program may comprise instructions which, when executed by one or more processors of the control circuit, cause the control circuit to perform operations as described within this document.

The computer program may be e.g. software/firmware which is loaded into the memory of the control circuit. To this end, the computer program may be transmitted over a network and the control circuit may comprise a network interface device for receiving the computer program. Alternatively, the computer program may be distributed on a data carrier and may be downloaded to the control circuit. In general, the computer program may be stored on a non-transitory computer-readable medium. This document discloses and claims a non-transitory computer-readable medium storing instructions that, when executed by one or more processors of a control circuit, cause the control circuit to perform the steps described throughout the document.

It should be noted that the methods and systems including its preferred embodiments as outlined in the present document may be used stand-alone or in combination with the other methods and systems disclosed in this document. In addition, the features outlined in the context of a system are also applicable to a corresponding method. Furthermore, all aspects of the methods and systems outlined in the present document may be arbitrarily combined. In particular, the features of the claims may be combined with one another in an arbitrary manner.

In the present document, the term “couple” or “coupled” refers to elements being in electrical communication with each other, whether directly connected e.g., via wires, or indirectly connected via other circuit elements between them. For example, two elements may be said to be coupled even if there is a circuit element such as a switch (which may be turned on and off) in between them. On the other hand, the term “connect” or “connected” refers to elements being directly electrically connected with each other, e.g. via wires, and no circuit elements are located between them.

### SHORT DESCRIPTION OF THE FIGURES

The present disclosed subject matter is illustrated by way of example, and not by way of limitation, in the figures in which like reference numerals refer to similar or identical elements, and in which

FIG. 1 shows an exemplary power converter topology,

FIG. 2 shows an exemplary flowchart of a current reduction method,

FIG. 3 shows an exemplary diagram of the upper current limit versus the measured temperature,

FIG. 4 shows an exemplary implementation of a temperature measurement using an NTC thermistor and corresponding signal waveforms, and

FIG. 5 shows another exemplary diagram of the upper current limit versus the measured temperature with hysteresis.

### DETAILED DESCRIPTION

Typically, the worst-case operating condition for thermals happens during maximum output power load and minimum input voltage. These applications are usually designed to operate under wide range universal input voltage from 85Vac up to 265Vac. In this case, 85Vac with maximum load power is usually the worst-case condition in meeting thermal requirement. At lower input voltage, the conduction related losses on the bridge rectifier, power factor correction converter stage and isolated dc-dc stage dominate which causes PSU efficiency to go down and temperature to increase. As the input voltage increases towards nominal input voltage conditions ~115V/230Vac efficiency and thermals are better relative to minimum input voltage. At highest input voltage ~265Vac, depending on the PSU topology used, the power losses usually increase again, and, in some designs, total losses would be at the highest level.

Common design practice is to ensure thermal compliance at this worst-case input voltage considering the maximum output power. In doing this, proper dimensioning must be done together with using right thermal management such as using heatsinks, thermal pads and thicker plastic enclosure to ensure no hotspot is generated and to meet the case temperature requirements. However, this adds additional system cost and makes the power supply bigger.

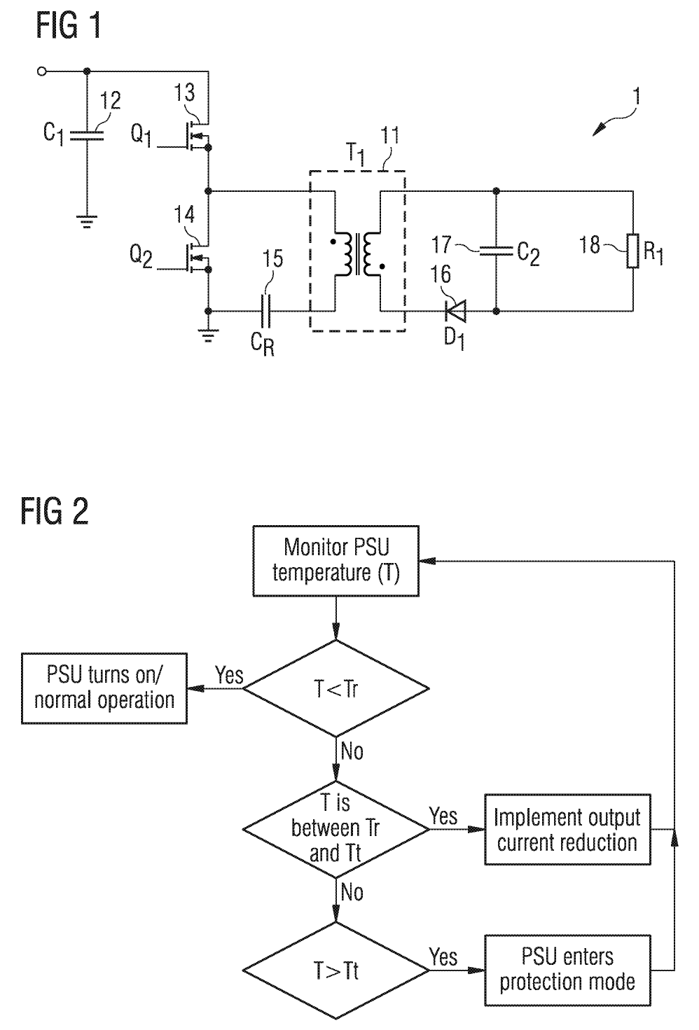

FIG. 1 shows an exemplary power converter topology which may be controlled by a controller (control circuit) proposed within this document. The power converter 1 comprises a transformer 11 which separates the power converter 1 into a primary side and a secondary side. On the primary side, the power converter 1 comprises an input capacitor 12, a high side switching element 13, a low side switching element 14, and a resonant capacitor 15. At this, switching element 13 and switching element 14 form a half-bridge. This half-bridge together with its dedicated driving circuitry is also denoted as power stage, or as power supply unit PSU throughout this document. On the secondary side, the power converter 1 comprises a rectifying diode 16, an output capacitor 17, and an output resistor 18.

It should be mentioned that the illustrated power converter 1 is exemplary in nature, and many variations exist. For instance, the primary winding of the transformer 11 and the resonant capacitor 15 may be connected in series to the high side switching element 13 instead being in series with the low side switching element 14 as illustrated. Alternatively, the rectifying diode 16 may be replaced by a synchronous rectification switching element which is controlled by an additional, secondary side controller which is often denoted a synchronous rectification controller. The controller (control circuit) presented within this document may be configured to control the switching elements 13 and 14 on the primary side. Moreover, this controller may be galvanically isolated from electrical signals stemming from the secondary side of the power converter 1.

FIG. 2 shows an exemplary flowchart of a current reduction method. Said method may be implemented in the controller based on two temperature thresholds sensed by means of a thermistor inside the PSU. If the temperature increases and falls between these two thresholds, the output current is reduced as a function of temperature. More specifically, FIG. 2 shows reducing the output current if the sensed temperature is between a release temperature Tr (denoted as first threshold value in the claims) and a trigger temperature Tt (denoted as second threshold value in the claims), and to enter protection mode if the sensed temperature exceeds the trigger temperature Tt. This scheme may allow meeting thermal specifications without overdesigning components.

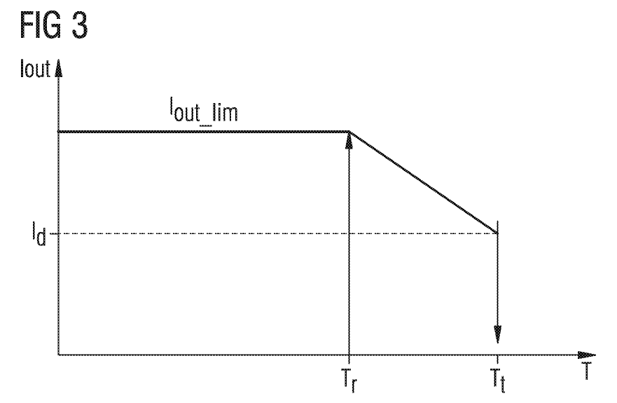

The external temperature (T) of the power supply may be measured by means of a negative temperature coefficient (NTC) thermistor (or other temperature sensor). As mentioned, there are two temperature thresholds: the lower limit Tr (release temperature) and higher limit Tt (trigger temperature). When T is below the lower limit Tr, the power supply is on and operating at normal operation. That is, output can reach 100% of the rated maximum current limit. When T increases and reaches Tr, current reduction will be implemented e.g. linearly depending on the temperature as shown on FIG. 3. FIG. 3 shows an exemplary diagram of the upper current limit versus the measured temperature. Here, the current is controlled and may depend on four variables Iout_limit, Id, Tt and Tr. The latter variables determine a slope of the upper current limit during the current foldback (i.e. between Tr and Tt). The temperature monitoring continues and when temperature reaches the upper threshold Tt, for some reasons, the power supply may be turned off. In this way, we ensure protection of the power supply against possible abnormal events. The power supply is then allowed to turn on again once the temperature falls below Tr.

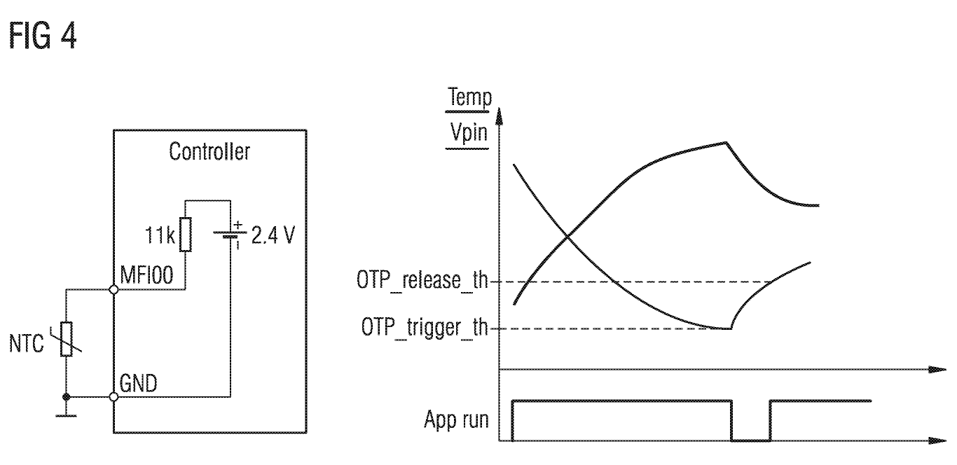

FIG. 4 shows an exemplary implementation of a temperature measurement using an NTC thermistor and corresponding signal waveforms. In this example, the temperature sensing is done by measuring the voltage across a multifunction input output MFIO pin. Tt is represented by the MFIO voltage, OTP_trigger_th while Tr is represented by the MFIO voltage: OTP_release_th. Since current limitation from the primary side may be set to a lower value of what the feedback requires, the feedback signal may be expected to increase and saturate. To provide the power derating functionality, the primary controller may need to disable the overcurrent protection OCP limits (based on a feedback voltage Vfb) if it detects T > Tr.

For example, reducing the output charging current to whenever the temperature exceeds the limit would not affect the operation of the power supply but limit the amount of heat dissipated internally. Therefore, if we could have constant monitoring of PSU temperature and reducing the output current or power linearly depending on the temperature once it exceeds a certain threshold, we can have more optimize, smaller and cheaper design.

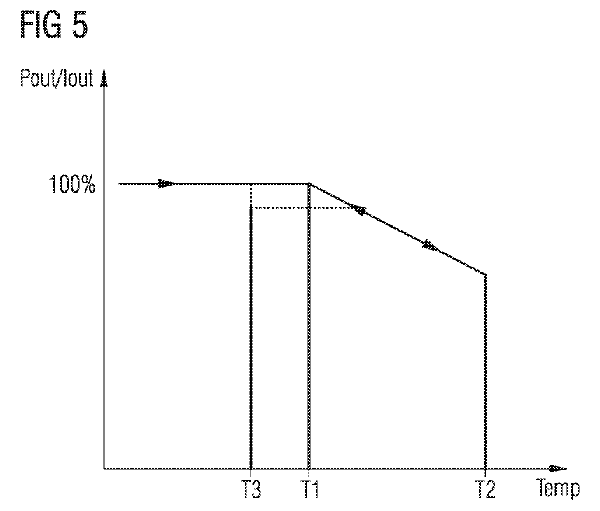

Finally, FIG. 5 shows another exemplary diagram of the upper current limit versus the measured temperature with hysteresis. For this purpose, a third threshold temperature T3 is introduced to prevent possible bouncing of the power supply operation from power foldback and normal operation.

It should be noted that the description and drawings merely illustrate the principles of the proposed methods and systems. Those skilled in the art will be able to implement various arrangements that, although not explicitly described or shown herein, embody the principles of the disclosed subject matter and are included within its spirit and scope. Furthermore, all examples and embodiment outlined in the present document are principally intended expressly to be only for explanatory purposes to help the reader in understanding the principles of the proposed methods and systems. Furthermore, all statements herein providing principles, aspects, and embodiments of the disclosed subject matter, as well as specific examples thereof, are intended to encompass equivalents thereof.

1. A control circuit configured to control operation of a power converter, wherein the control circuit is configured to:
receive a temperature value from a temperature sensor; and
control an output current of the power converter based on the temperature value.

2. The control circuit according to claim 1, wherein the control circuit is configured to:
reduce the output current of the power converter if the temperature value exceeds a first threshold value.

3. The control circuit according to claim 2, wherein the control circuit is configured to:
linearly reduce the output current over temperature between the first threshold value and a second threshold value.

4. The control circuit according to claim 1, wherein the control circuit is configured to:
keep the output current below an upper current limit; and
reduce the upper current limit if the temperature value exceeds a first threshold value.

5. The control circuit according to claim 4, wherein the control circuit is configured to:
linearly reduce the upper current limit over temperature between the first threshold value and a second threshold value.

6. The control circuit according to claim 4, wherein the control circuit is configured to:
reduce the upper current limit only based on the temperature value, and independent of other feedback parameters of the power converter.

7. The control circuit according to claim 4, wherein the control circuit is configured to:
receive another feedback parameter indicative of the output current or an output voltage of the power converter; and
control the output current based on said another feedback parameter under the condition that the output current does not exceed the upper current limit.

8. The control circuit according to claim 1, wherein the control circuit is configured to:
enter protection mode and shut down operation of the power converter if the temperature value exceeds a second threshold value.

9. The control circuit according to claim 1, wherein the power converter comprises a transformer with a primary side and a secondary side, and wherein the control circuit is configured to:
control the output current of the power converter based on the temperature value by controlling the switching behavior of switching elements coupled to the primary side of the transformer.

10. The control circuit according to claim 9, wherein the power converter comprises a resonant capacitor and a half-bridge coupled to the primary side of the transformer, and wherein the switching elements form said half-bridge.

11. The control circuit according to claim 1, wherein the control circuit is configured to:
ignore, if the temperature value exceeds a first threshold value, an overcurrent protection function based on a feedback voltage indicative of an output voltage of the power converter.

12. The control circuit according to claim 1, wherein the temperature sensor comprises a thermistor, and wherein the temperature value comprises a voltage across said thermistor.

13. A battery charger device comprising a control circuit and a power converter according to claim 1.

14. The battery charger device according to claim 13, wherein the power converter comprises a transformer with a primary side and a secondary side, wherein the control circuit is configured to:
control the output current of the power converter based on the temperature value by controlling the switching behavior of switching elements coupled to the primary side of the transformer, wherein the control circuit is galvanically isolated from electrical signals of the secondary side of the transformer.

15. A method of controlling a power converter, the method comprising
receiving, by a control circuit, a temperature value from a temperature sensor; and
controlling, by the control circuit, an output current of the power converter based on the temperature value.

16. The method according to claim 15, comprising:
reducing the output current of the power converter if the temperature value exceeds a first threshold value.

17. The method according to claim 16, comprising:
linearly reducing the output current over temperature between the first threshold value and a second threshold value.

18. The method according to claim 15, comprising:
keeping the output current below an upper current limit; and
reducing the upper current limit if the temperature value exceeds a first threshold value.

19. A computer program comprising instructions which, when executed by one or more processors of a control circuit, cause the control circuit to perform operations comprising:
receiving a temperature value from a temperature sensor; and
controlling an output current of a power converter based on the temperature value.

20. The computer program according to claim 19, the operations comprising:
entering protection mode and shutting down operation of the power converter if the temperature value exceeds a second threshold value.
